(19) United States
(12) Patent Application Publication
(10) Pub. No.: US 2025/0033662 A1
(43) Pub. Date: Jan. 30, 2025

(54) METHOD FOR ASSISTIVE OR AUTOMATED VEHICLE CONTROL

(71) Applicant: Continental Autonomous Mobility Germany GmbH, Ingolstadt (DE)

(72) Inventors: Lars Krüger, Ulm (DE); Aldin Pejic, Frankfurt am Main (DE)

(73) Assignee: Continental Autonomous Mobility Germany GmbH, Ingolstadt (DE)

(21) Appl. No.: 18/710,376

(22) PCT Filed: Nov. 15, 2021
(86) PCT No.: PCT/EP2021/081663

§ 371 Date: May 15, 2024

(51) Int. Cl. B60W 60/00

(52) U.S. Cl. CPC B60W 60/001; B60W 2420/403; B60W 2420/408; B60W 2420/54; B60W 2554/20; B60W 2554/40; B60W 2554/80; B60W 2556/10

(57) ABSTRACT

A method for the assistive or automated vehicle control of an ego-vehicle, the ego-vehicle including a control device and at least one sensor for environment and object detection. For the vehicle control of the ego-vehicle, trajectory planning is carried out on the basis of the detected environment and the detected objects, boids which are defined on the basis of rules of attraction and repulsion are generated for the objects, and the trajectory planning is performed on the basis of the boids, and the method includes the following method steps: initialization, wherein the boids are transferred into a coordinate system, applying the rules of attraction and repulsion, and simulation according to a definable movement model.

### CROSS-REFERENCE TO RELATED APPLICATIONS

The present application is a National Stage Application under 35 U.S.C. § 371 of International Patent Application No. PCT/EP2021/081663 filed on Nov. 15, 2021 in the German Patent and Trademark Office, the disclosure of which is herein incorporated by reference in its entirety.

### TECHNICAL FIELD

The present invention relates to a method, in particular a computer-implemented method, for the assistive or automated vehicle control of an ego-vehicle as well as a driver assistance system for an ego-vehicle for the assistive or automated vehicle control of the ego-vehicle.

### BACKGROUND

Generic vehicles such as, e.g., passenger vehicles (cars), trucks or motorcycles, are increasingly equipped with driver assistance systems which, with the aid of sensor systems, can detect the surroundings or the environment, recognize traffic situations and assist the driver, e.g., by a braking or steering intervention or by outputting a visual, haptic or acoustic warning. Radar sensors, lidar sensors, camera sensors, ultrasonic sensors or the like are regularly deployed as sensor systems for environment detection. Conclusions can subsequently be drawn about the surroundings from the sensor data established by the sensors, with which, e.g., a so-called environment model can also be generated. Based thereon, instructions for waring/informing the driver or for regulating the steering, braking and acceleration can subsequently be output. Thanks to the assistance functions which process sensor and environment data, e.g., accidents with other traffic participants can be avoided or complicated driving maneuvers can be facilitated by assisting with or even completely taking over the driving task or the vehicle control (in a partially or fully automated manner). For example, the vehicle can, e.g., perform Autonomous Emergency Braking (AEB) by means of an Emergency Brake Assist (EBA) or control the speed and distance when following vehicles by means of Adaptive Cruise Control (ACC).

Furthermore, the trajectory to be driven or the movement path of the vehicle can be determined. Static targets or objects can be captured on the basis of the sensor technology, as a result of which, e.g., the distance from a vehicle driving ahead or the course of the road or the route can be estimated. The capturing or recognition of objects, and in particular checking the plausibility thereof, is of particular importance in order to recognize, for example, whether a vehicle driving ahead is relevant to the respective assistance function or control. In this case, one criterion is that, e.g., an object recognized as a target vehicle (target) is driving in the same lane as the driver's own vehicle (ego-vehicle). Known driver assistance systems try to estimate the course of a lane, e.g., with the aid of the sensor technology, in order to establish whether a target vehicle is located in the driver's own lane. To this end, both information about the lane markings, roadside developments and the path taken by other vehicles is utilized. Furthermore, a suitable algorithm (e.g., curve-fitting algorithm) is applied in order to predict the future path or the trajectory of the ego-vehicle. Moreover, a deviation of the other traffic participants from this path can be utilized in order to decide in which lane the respective traffic participant is driving.

Known systems either do not utilize reliability information or use ideal reliability information, e.g., the standard deviation of a measured variable. However, these error models for sensors are not sufficiently precise in order to utilize the reliability information, e.g., directly as a weighting factor. There are primarily two key sources of errors: an incorrect prediction of the course of the driver's own lane and an incorrect/unreliable measurement of the position of the observed traffic participant or the other traffic participants, which can lead to too great a deviation from the predicted path. Both sources of errors can only be corrected with knowledge of correct reliability information. This results in a high computational cost and poor scalability, both to multiple objects and to new object types. However, in driver assistance functions such as, in particular, ACC, relevant objects have to already be selected, for the most part, at great distances. To this end, the object detection is carried out, as a general rule, via a radar sensor which has a sufficient sensor range and capturing reliability. Nevertheless, the quality of the geometric or kinematic estimates at the start of the measurement is frequently still too poor or too few measurements were performed or too few measuring points generated. The variations in the applied filters are frequently too great so that it is not possible, e.g., to assign lanes sufficiently reliably to radar objects, for example at a distance of 200 meters.

DE 10 2015 205 135 A1 discloses a method in which the relevant objects of a scene (e.g., guardrails, lane center lines, traffic participants) are represented as objects in a swarm: the objects are recognized by means of external sensor technology and are represented in object constellations, wherein an object constellation comprises two or more objects, i.e., measurements/objects are combined in order to save computing time and to increase the accuracy of the estimation. Accordingly, the combinations of different measurements of the same object represent technically necessary constellations in order to attain a saving in computing time, but not semantic constellations, since they relate to different measurements of the same object and not different objects. The data of the external sensor technology can be, for example, raw sensor data or pre-processed sensor data and/or sensor data selected according to predetermined criteria. For example, this can be image data, laser scanner data or object lists, object contours or so-called point clouds (which represent, e.g., an arrangement of specific object parts or object edges).

### SUMMARY

Proceeding from the prior art, an aspect of the present disclosure is to provide a method which can increase the accuracy of the estimation with an advantageous computing time.

In the case of the method according to the present disclosure for the assistive or automated vehicle control of an ego-vehicle, the ego-vehicle includes a control device and at least one sensor, such as multiple sensors, for environment detection, wherein the sensors detect objects in the environment of the ego-vehicle. Furthermore, trajectory planning is carried out on the basis of the detected environment, wherein the vehicle control of the ego-vehicle is carried out on the basis of the trajectory planning, with the objects in the environment being enlisted for trajectory planning. Boids, which are defined on the basis of rules of attraction and repulsion, are then generated for the objects. The trajectory planning is then carried out on the basis of the boids. This results in the advantage that the accuracy of the estimation may be increased and the required computing time can be reduced to a particular extent. Furthermore, the method according to the present disclosure includes the method steps of initialization, wherein the objects or the generated boids (OSBs—object selection boids) are transferred into a coordinate system (or ego coordinate system), applying the rules of attraction and repulsion, and simulation according to a definable movement model. As a result, different measurement data are utilized in a simple and flexible manner, without special handling of the question of whether and which measurement data are available or not. If further measurement data are available, they are used and lead to even better results. If measurement data are missing, a sufficiently good result is still achieved with the remaining measurement data.

Within the meaning of the present disclosure, the term trajectory planning also expressly includes, in addition to planning in space and time (trajectory planning), purely spatial planning (path planning). Accordingly, the boids may also only be used in part of the system, e.g., in order to adapt the speed or for the selection of a specific object (“Object-of-Interest Selection”).

The rules of attraction and repulsion may be defined by defining objects which are arranged close to one another and parallel as attractive boids, and by defining objects which are arranged parallel and at a greater distance from one another as repulsive boids.

Expediently, repulsive boids can be defined for static objects and attractive boids may be defined for moving objects. Moving objects may be observed over a period of time so that a movement history is created, and boids are attracted (or conversely repelled) on the basis of the movement history.

According to an advantageous embodiment of the present disclosure, moving objects may be observed (tracked) over a period of time so that a movement history is created, and attractive boids may be defined on the basis of the movement history.

Furthermore, the detected objects and/or the boids may be stored in an object list, in which all of the detected objects with all of the detected data (position, speed, signal strength, classification, elevation and the like) are stored.

A feature space may be expediently defined on the basis of the position and direction of movement of the ego-vehicle, wherein the rules of attraction for all of the boids may be converged on one point in the feature space. As a result, the measurement accuracy may be additionally improved.

The feature space may be defined on the basis of the clothoid parameters of the trajectory planning.

The feature space may advantageously also be extended to other traffic participants. As a result, the measurement accuracy may be increased to a particular extent; in addition, the recognition of the environment is improved to a particular extent.

At least one camera and/or a lidar sensor and/or a radar sensor and/or an ultrasonic sensor and/or another sensor known from the prior art for environment detection may be expediently provided as the sensor for environment detection.

Furthermore, the behavior rules or the rules of attraction and repulsion may be represented as a composition of simple behavior rules. The behavior rules or the rules of attraction and repulsion may be realized geometrically, by control technology or logically.

The behavior rules or the rules of attraction and repulsion may be expediently realized on the basis of a prioritization, weighting and/or averaging.

In addition, a swarm model (based on the behavior of a swarm or flock of birds) may also be enlisted, wherein a collision of the swarm participants is avoided or a clash with other swarm participants is prevented by adjusting the direction. Furthermore, the speed is adjusted to the neighboring swarm participants, in order to keep pace with the neighbors and to promote both staying together and collision avoidance. Swarm centering is also carried out, wherein an adjustment of the direction is provided so that boids remain in the vicinity of the swarm. This is achieved solely by being centered with the immediate neighbors. If, by way of example, a boid is located at the edge of the swarm, more neighbors are located in the direction of the swarm center and, consequently, the center of the immediate neighbors is also located in the direction of the swarm center.

In an alternative, independent claim, the present disclosure includes, in addition, a driver assistance system for an ego-vehicle for the assistive or automated vehicle control of the ego-vehicle, the ego-vehicle including a control device and at least one sensor, such as multiple sensors, for environment detection, wherein the sensors detect objects in the environment of the ego-vehicle. The control device performs trajectory planning on the basis of the detected environment, wherein the vehicle control of the ego-vehicle is carried out on the basis of the trajectory planning. The sensor for environment and object detection may be, e.g., a radar sensor, a lidar sensor, a camera sensor or an ultrasonic sensor. The objects are enlisted for trajectory planning, wherein boids which are defined on the basis of rules of attraction and repulsion are generated for the objects such that the trajectory planning may then be performed, taking account of the boids.

Furthermore, the driver assistance system may be a system which, in addition to a sensor for environment detection, includes a computer, processor, controller, data processor or the like in order to perform the method according to the present disclosure. A computer program may be provided with program code for performing the method according to the present disclosure when the computer program is run on a computer or another programmable data processor known from the prior art. Accordingly, the method may also be executed or retrofitted in existing systems as a computer-implemented method. Within the meaning of the present disclosure, the term “computer-implemented method” describes the process planning or procedure which is brought to fruition or performed on the basis of the computer. The computer may process the data by means of programmable calculation specifications. With regard to the method, properties may consequently also be subsequently implemented, e.g., by a new program, new programs, an algorithm or the like. The computer may be configured as a control device or as part of the control device (e.g., as an IC (Integrated Circuit) module, microcontroller or System-on-Chip (SoC)).

As a consequence, the method describes a relationship between objects detected by the sensors and a swarm of semantically defined boids which are displaced, so to speak, between the boids themselves and the detected objects on the basis of rules of attraction and repulsion (behavior rules). The trajectory planning may then be performed on the basis of the sensor data of the objects which have been selected by the boids. According to a particular embodiment of the present disclosure, the boids may be displaced again in each processing cycle from an identical starting point. Furthermore, the boids may also be displaced in each processing cycle based on the positions of the boids from the last cycle.

### BRIEF DESCRIPTION OF THE DRAWINGS

The present disclosure is explained in greater detail below with reference to expedient exemplary embodiments, wherein:

FIG. 1 shows an extremely simplified schematic representation of an ego-vehicle with an assistance system according to the present disclosure;

FIG. 2 shows a simplified representation of a traffic scene, in which an ego-vehicle drives through a curve which has already been driven through by multiple other vehicles;

FIG. 3 shows a simplified representation of the traffic scene from FIG. 2, in which the measuring principle according to the present disclosure is represented on the basis of different measuring points, and

FIG. 4 shows a simplified schematic representation of an embodiment of the mode of operation of a navigation module for individual OSBs.

### DETAILED DESCRIPTION

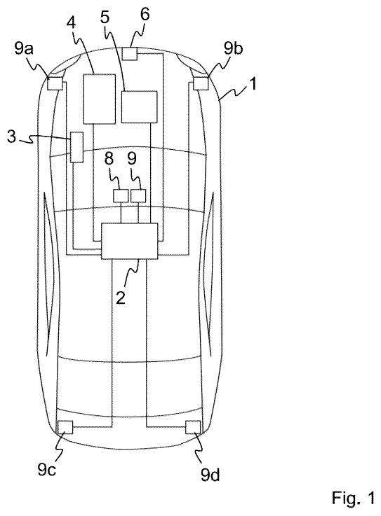

Reference numeral 1 in FIG. 1 designates an ego-vehicle which has a control device (ECU, Electronic Control Unit or ADCU, Assisted and Automated Driving Control Unit), different actuators (steering 3, engine 4, brake 5) as well as sensors for environment detection (camera 6, lidar sensor 7, radar sensor 8 as well as ultrasonic sensors 9a-9d). The ego-vehicle 1 may be controlled in a (partially) automated manner in that the control device 2 may access the actuators and the sensors or their sensor data. In the field of assisted or (partially) automated driving, the sensor data may be utilized for environment and object recognition such that different assistance functions such as, e.g., Adaptive Cruise Control (ACC), Electronic Brake Assist (EBA), Lane Keep Assist (LKA,), parking assistant or the like can be realized via the control device 2 or the algorithm stored therein.

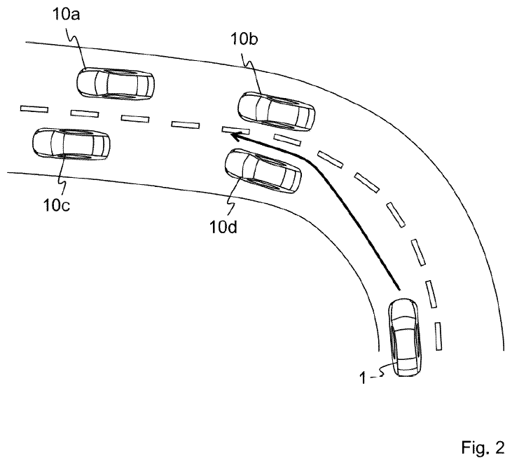

FIG. 2 depicts a typical traffic scene in which the ego-vehicle 1 enters a curve which was previously driven through by multiple vehicles driving ahead 10a, 10b, 10c, 10d. In this case, the ego-vehicle 1 may capture the surrounding objects (vehicles driving ahead 10a-10d, roadway markings, roadside developments and the like) on the basis of the sensors for environment detection, and may create its own path or the trajectory to be driven on the basis of this information. Furthermore, movements of other traffic participants may be predicted and enlisted for trajectory planning. For example, the trajectory (depicted on the basis of a black arrow) created on the basis of the capturing points and movement prediction of the vehicle 11d is, however, suboptimal or incorrect, since it does not follow the course of the lane due to the movement prediction of vehicle 10d, but would result in an unwanted lane change in the curve area.

In the case of the method according to the present disclosure, the relevant objects of a scene (guardrails, lane center lines, traffic participants and the like) are now represented as objects in a swarm (i.e., as a kind of association or amalgamation of objects). In contrast to a known simple combination of objects (simple cluster), the detected objects are not only combined, but are preserved as individuals and influence each other, i.e., they interact with one another. The behavior of these objects is defined with simple rules based on the sensor data and the relationships with one another, i.e., the interaction of objects similarly to so-called boids (interacting objects for simulating swarm behavior). In this case, a boid corresponds to a measured object and not a combined constellation of objects, i.e., the boids semantically represent individual objects and not simple constellations. In the case of boid-based models, the complexity of the model is the result of the interaction of the individual objects or boids which follow simple rules such as, e.g., separation (a movement or directional choice which counters an accumulation of boids), assimilation (a movement or directional choice which corresponds to the mean direction of the neighboring boids), or cohesion (a movement or directional choice which corresponds to the mean position of the neighboring boids).

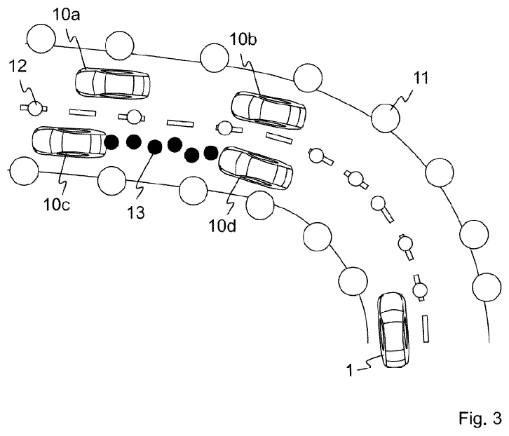

FIG. 3 depicts the measuring principle with boids 11, 12, 13 of road markings and vehicles or their driving paths using the example of the road scene from FIG. 2. For example, a new measurement of a road marking (e.g., modeled as a sectional straight line) is added to the existing list of road marking objects in each cycle. Thereafter, the rules of attraction and repulsion are calculated (e.g., objects which are close and parallel attract each other; objects which are parallel but at a greater distance repel each other). Consequently, repulsive boids 11 for the edges of the roadway and repulsive boids 12 for the middle of the roadway may be generated (e.g., on the basis of captured road markings, guardrails and roadside developments). The vehicles 10a-10d may also be represented in a similar way. In this case, a vehicle recognized by the sensors is, e.g., represented as a short movement history. For example, the attractive boids 13 represent the vehicle 10c or its movement path in that the boids 13 were generated on the basis of the movement history of the vehicle 10c. This measurement or the established boids is/are inserted in a similar way into the list of the previous measurements (object list) and their position corrected by means of the compiled rules.

Expediently, e.g., errors in the lane course estimation as a result of observing the path driven by other vehicles 10a-10d may now be compensated for by the ego-vehicle 1 or the vehicles performing their trajectory planning, taking into account specified rules. For example, the following may be provided as rules: “Guardrails are parallel to lanes”, “The lanes have an at least approximately constant width”, “The vehicles drive parallel to the lanes”, “The guardrails run on average through the measuring points”, “The guardrails do not have any kinks or branches” or the like. This automatically results in paths (“emergent behavior”) or trajectories, the course of which is parallel to the guardrails. Furthermore, the measured values may also be weighted in a definable manner, similarly to the case of, e.g., αβ filters.

An increase in the measurement accuracy is in particular achieved in that the rules of attraction allow all of the measurements (which each correspond to a boid) to converge on the same point in the feature space. The feature space includes the position and direction of the ego-vehicle 1. Surprisingly, this principle may also be extended to other traffic participants or vehicles in that, e.g., “Vehicles drive parallel to the lanes” (i.e., the same rule as in the case of static objects, only now the modeled positions of the vehicles are changed), “Vehicles do not collide with one another”, “Vehicles in the same lane align with one another” (“driving in a convoy”), “Vehicles do not collide with the guardrail” and the like.

Alternatively, the space of the clothoid parameters of the trajectory may also be selected as the feature space. In that case, the individual boids would be individual measurements over time. Here, the boids could, e.g., be longitudinally fixed and only move in a lateral direction and in terms of their curvatures by virtue of the rules. In a practical manner, the boids may be deleted in this case as soon as the ego-vehicle 1 has driven past them. As a result, storage and computing time in particular can be saved. Other than that, boids which represent the same object in the real world (e.g., when the boids form a compact cluster having a specified spread) could be combined in order to save storage and computing time.

It is now illustrated below how the components of an OSB (object selection boid) swarm are combined to produce a self-organizing system with emergent behavior, wherein the term OSB stands for a swarm participant in the OSB swarm, and how this system or the OSB swarm may be applied to the situation recognition for an ACC function. Following each update cycle of the sensor technology, a new surroundings model may be generated, wherein the update cycle is the time during which the sensor technology measures and generates a surroundings model. The surroundings model contains a list of all of the traffic participants (TP) which have been detected by the sensor technology for the current update cycle. This list then contains information such as positions of the routes and traffic participants which are used for the self-organizing system or the OSB swarm. The OSB swarm is sent once via the traffic participants and routes in this list for each update cycle, and the individual OSBs assign the traffic participants their corresponding roles and store these in the list. This means that following each update cycle of the surroundings model, the OSB swarm is simulated once for a specific number of simulation steps and moves through the traffic participants and routes.

The simulation the be divided into the following three method steps: initialization, applying the behavior rules, and simulation according to a definable movement model. In the first step of the simulation, the OSB swarm is initialized, wherein the OSBs are placed in the ego coordinate system of the surroundings model. The current number of selected traffic participants, the directional angle θ and the steering angle β of all of the OSBs are set to zero. The speed v of all of the OSBs is set to the initial speed vᵢₙᵢₜ. The OSB representing the ego-lane, i.e., the OSB driving ahead of the ego-vehicle, is placed on the ego-vehicle and the remaining OSBs are arranged thereon on the sides, each with a distance d_{lat,init}. At the start, the x-position in the ego coordinate system corresponds to zero for all of the objects. A further possible embodiment is to initialize the directional angle θ, the steering angle β and/or the x- and y-positions of the OSBs from sensor data or data from a navigation map. This step is executed again for each new simulation or each new update cycle of the surroundings model.

Furthermore, the behavior of the OSBs may now be determined, in the second step, by means of the behavior rules or the rules of attraction and repulsion and the navigation (in particular by means of the navigation module). To this end, both the neighboring OSBs and the traffic participants and routes in the current surroundings model must first be transformed from the ego coordinate system into an OSB coordinate system. Parallel to this, it is calculated which traffic participants and routes are located in the respective field of vision of the OSBs. Next, the respective behavior rules may then be applied by means of the transformed coordinates, e.g., a traffic participant is to be followed, and/or a distance from one or more traffic participants is to be kept and/or the initial position in the initialization step is to be maintained (in particular, the formation and distances in the swarm are maintained).

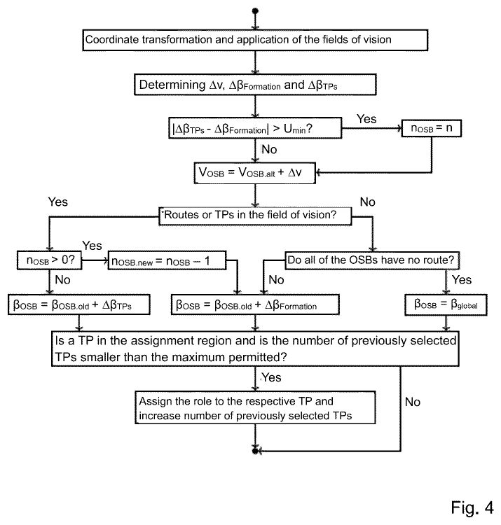

The behavior rules may supply a speed change Δv or steering angle changes Δβ. The navigation module then adds these changes to the current speed v and the current steering angle β of the respective OSB. A prioritization of the changes may be applied. If routes or traffic participants are located in the field of vision of the respective OSB, a specific steering angle change may be prioritized and, consequently, only this can be applied. If there are no routes in the field of vision, only the changes to the formation may be applied. Parallel to this, the navigation module may check whether there is a discrepancy between the change in formation and the change in the respective traffic participant. If the discrepancy exceeds a definable limit, the prioritization for following the traffic participants for the respective OSB is ignored for n simulation steps and the OSB is controlled by means of the formation change and pushed or moved back into the formation. If no route or traffic participant is located in the field of vision for all of the OSBs, a global steering angle to a global target may be specified for each navigation module of the OSBs and selected as the steering angle for the OSBs until a route is found again. Further global targets may be inferred, e.g., from navigation maps, other sensor data and/or V2X communication data. In this case, each OSB determines the respective behavior rules for itself, i.e., it only looks at its respective OSB neighbors or traffic participants and routes in its field of vision. The movement is determined in a decentralized manner by the local surroundings, which corresponds to the necessary properties of a self-organizing system. An exemplary mode of operation of the navigation module thus created for each OSB is depicted in FIG. 4.

After the speeds and steering angles of the OSBs have been changed in the second step by means of the behavior rules, the OSB swarm be simulated in the third step for a simulation step. To this end, all of the OSBs are simulated and updated. Thereafter, steps two and three be repeated for a definable number of simulation steps until the OSB swarm has moved once across the entire field of vision of the ego-vehicle and the simulation of the OSB swarm has been completed for one update cycle and the correct role has been assigned or the multi-object selection is done. In order to further improve the selection, the preceding assignment for preceding cycles may be saved. Now, if the situation occurs that a traffic participant is not assigned by the OSB swarm in the current update cycle, the assignment from the last cycle is adopted. This assignment is preserved for three cycles unless a new assignment takes place in between. If there is still no assignment after multiple cycles, the traffic participant is no longer assigned a role. Moreover, a hysteresis may be realized with the preceding assignment. The assignment which occurs most frequently in three cycles, the current cycle plus the two previous cycles, is always selected, thus making it possible to prevent toggling back and forth between two assignments in a short period of time.

Furthermore, a bicycle model or single-track model or semi-vehicle model which comprises, e.g., three state variables, the directional angle θ, x- and y-positions related to the ego coordinate system, may be provided as the movement model, for example. The speed v and the steering angle β are available as input variables via which the model may be influenced and, therefore, ultimately the individual OSBs of the swarm can be controlled. A direct change in the steering angle may be assumed for the OSBs in order to simplify the model and the control of the OSBs. The simplification is possible since the OSBs are only needed for multi-object selection and a real trajectory which the ego-vehicle is to follow is not specified. Furthermore, other movement models known from the prior art can, of course, also be provided.

### LIST OF REFERENCE NUMERALS

1 Ego-vehicle
2 Control device
3 Steering
4 Engine
5 Brake
6 Camera
7 Lidar sensor
8 Radar sensor
9a-9d Ultrasonic sensors
10a Vehicle
10b Vehicle
10c Vehicle
10d Vehicle
11 Boid (road marking—roadside)
12 Boid (road marking—center of lane)
13 Boid (movement of the vehicle 10c)

1. A method for the assistive or automated vehicle control of an ego-vehicle,
the ego-vehicle comprising a control device and at least one sensor for environment and object detection, the control device including electronic circuitry, wherein the method comprises:
performing trajectory planning for the vehicle control of the ego-vehicle on the basis of the detected environment and the detected objects,
defining and generating boids on the basis of rules of attraction and repulsion for the objects,
wherein the trajectory planning is performed on the basis of the boids, and
performing initialization wherein the boids are transferred into a coordinate system,
applying the rules of attraction and repulsion, and
simulating according to a definable movement model.

2. The method according to claim 1, further comprising defining the rules of attraction and repulsion by defining objects which are arranged close to one another and parallel as attractive boids, and by defining objects which are arranged parallel and at a greater distance from one another as repulsive boids.

3. The method according to claim 2, wherein the repulsive boids are defined for static objects and the attractive boids are defined for moving objects.

4. The method according to claim 2, further comprising observing moving objects are a period of time so that a movement history is created, and the attractive boids are defined on the basis of the movement history.

5. The method according to claim 1, wherein at least one of the detected objects or the boids are stored in an object list.

6. The method according to claim 1, further comprising defining a feature space from a position and a direction of the ego-vehicle, wherein the rules of attraction for all boids are converged on one point in the feature space.

7. The method according to claim 6, wherein the feature space is defined on the basis of clothoid parameters of the trajectory planning.

8. The method according to claim 6, further comprising extending the feature space to other traffic participants.

9. The method according to claim 1, further comprising providing a camera, a lidar sensor, a radar sensor or an ultrasonic sensor as the at least one sensors for environment detection.

10. The method according to claim 1, wherein the rules of attraction and repulsion are represented as a composition of simple behavior rules.

11. The method according to claim 1, the rules of attraction and repulsion are realized geometrically, by control technology or logically.

12. The method according to claim 1, wherein the rules of attraction and repulsion are realized on the basis of at least one of a prioritization, weighting or averaging.

13. A driver assistance system for an ego-vehicle for the assistive or automated vehicle control of the ego-vehicle, comprising
the control device and the at least one sensor for environment and object detection, wherein the control device performs trajectory planning on the basis of the method according to claim 1.
